(19) United States
(12) Patent Application Publication
(10) Pub. No.: US 2024/0351933 A1
(43) Pub. Date: Oct. 24, 2024

(54) OPTICAL GLASS PLATE

(71) Applicant: NIPPON ELECTRIC GLASS CO., LTD., Otsu-shi, shiga (JP)

(72) Inventor: Satoko KONOSHITA, Otsu-shi, Shiga (JP)

(73) Assignee: NIPPON ELECTRIC GLASS CO., LTD., Otsu-shi, shiga (JP)

(21) Appl. No.: 18/682,318

(22) PCT Filed: Aug. 2, 2022
(86) PCT No.: PCT/JP2022/029687

§ 371 Date: Feb. 8, 2024

(30) Foreign Application Priority Data
Aug. 12, 2021 (JP) 2021-131571
Mar. 30, 2022 (JP) 2022-056846

(51) Int. Cl. C03C 3/068; C03C 3/062

(52) U.S. Cl. CPC C03C 3/068; C03C 3/062

(57) ABSTRACT

To provide an optical glass plate having refractive index properties higher than those of an optical glass plate in the related art. An optical glass plate contains, in terms of mass %, 0% to 12% of SiO₂, 0% to 10% of B₂O₃, 0% to 9% of BaO, 0% to 5% of ZnO, 2% to 10% of ZrO₂, 15% to 45% of La₂O₃, 0% to 15% of Gd₂O₃, 0% to 15% of Nb₂O₅, 0% to 10% of WO₃, 15% to 50% of TiO₂, and 0.1% to 10% of Y₂O₃, in which a ratio Y³⁺/(Gd³⁺+Y³⁺+Yb³⁺) is 0.2 or more in terms of cation %, a refractive index nd is 2.01 or more, and an Abbe number vd is 35 or less.

### TECHNICAL FIELD

The present invention relates to an optical glass plate used as a light-guiding plate or the like of a wearable image display device.

### BACKGROUND ART

A glass plate is used as a constituent member of a wearable image display device such as projector-equipped glasses, an eyeglass-type or goggle-type display, a virtual reality (VR) or augmented reality (AR) display device, and a virtual image display device. The glass plate functions, for example, as a see-through light-guiding plate, and it is possible to view an image displayed on the glass plate while viewing an external scenery through the glass plate. Further, it is also possible to realize 3D display using a technique that projects different images on left and right sides of glasses, or realize a virtual reality space using a technique that uses the crystalline lens of the eye to connect to the retina. The glass plate is required to have a high refractive index in order to widen an angle of the image, increase brightness and contrast, and improve light guiding properties (see, for example, Patent Literature 1).

### CITATION LIST

### Patent Literature

Patent Literature 1: JP2017-32673A

Patent Literature 2: JP6517411B

### SUMMARY OF INVENTION

### Technical Problem

In order to improve the performance of the wearable image display device, the glass plate is required to have an even higher refractive index. In order to improve the refractive index of the glass plate, it is effective to contain a component such as TiO₂, which contributes to a high refractive index, in a glass. However, when a large amount of such a high refractive index component is contained in the glass, vitrification may be difficult.

In view of the above, an object of the present invention is to provide an optical glass plate having refractive index properties higher than those of an optical glass plate in the related art.

### Solution to Problem

As a result of intensive studies, the inventor of the present invention have found that the above problems can be solved by using an optical glass plate having a predetermined composition. Hereinafter, each aspect of the optical glass plate that solves the above problems will be described.

That is, an optical glass plate according to aspect 1 contains, in terms of mass %, 0% to 12% of SiO₂, 0% to 10% of B₂O₃, 0% to 9% of BaO, 0% to 5% of ZnO, 2% to 10% of ZrO₂, 15% to 45% of La₂O₃, 0% to 15% of Gd₂O₃, 0% to 15% of Nb₂O₅, 0% to 10% of WO₃, 15% to 50% of TiO₂, and 0.1% to 10% of Y₂O₃, in which a ratio Y³⁺/(Gd³⁺+Y³⁺Yb³⁺) is 0.2 or more in terms of cation %, a refractive index nd is 2.01 or more, and an Abbe number vd is 35 or less.

An optical glass plate according to aspect 2 is based on aspect 1, in which an internal transmittance 1450 at a wavelength of 450 nm at a thickness of 10 mm is preferably 70% or more.

An optical glass plate according to aspect 3 is based on aspect 1 or aspect 2, in which a thickness is preferably 1 mm or less.

An optical glass plate according to aspect 4 is based on any aspect of aspect 1 to aspect 3, in which a major axis of a main surface is preferably 100 mm or more.

An optical glass plate according to aspect 5 is based on any aspect of aspect 1 to aspect 4, in which a liquidus viscosity is preferably 100.1 dPa·s or more.

An optical glass plate according to aspect 6 is based on any aspect of aspect I to aspect 5, in which a density is preferably 5.5 g/cm³ or less.

A light-guiding plate according to aspect 7 includes the optical glass plate according to any one of aspect 1 to aspect 6.

A light-guiding plate according to aspect 8 is based on aspect 7 and is preferably used in a wearable image display device selected from projector-equipped glasses, an eyeglass-type or goggle-type display, a virtual reality (VR) or augmented reality (AR) display device, and a virtual image display device.

A wearable image display device according to aspect 9 includes the light-guiding plate according to aspect 7 or aspect 8.

### Advantageous Effects of Invention

According to the present invention, it is possible to provide an optical glass plate having refractive index properties higher than those of an optical glass plate in the related art.

### DESCRIPTION OF EMBODIMENTS

An optical glass plate according to the present invention contains, in terms of mass %, 0% to 12% of SiO₂, 0% to 10% of B₂O₃, 0% to 9% of BaO, 0% to 5% of ZnO, 2% to 10% of ZrO₂, 15% to 45% of La₂O₃, 0% to 15% of Gd₂O₃, 0% to 15% of Nb₂O₅, 0% to 10% of WO₃, 15% to 50% of TiO₂, and 0.1% to 10% of Y₂O₃, in which a ratio Y³⁺/(Gd³⁺+Y³⁺+Yb³⁺) is 0.2 or more in terms of cation %. Reasons for limiting the glass composition in this way will be described below. Note that, in the description regarding a content of each component below, “%” means “mass %” unless otherwise specified.

SiO₂ is a glass frame component and is a component that improves vitrification stability and chemical durability. However, when the content thereof is too large, the melting temperature becomes extremely high. When the melting temperature is high, transition metal components such as Nb and Ti are reduced, absorption occurs in a visible region, and an internal transmittance tends to decrease. In addition, a refractive index tends to decrease. A lower limit of the content of SiO₂ is preferably 0% or more, 3% or more, 5% or more, 5.5% or more, and particularly preferably 6% or more, and an upper limit thereof is preferably 12% or less, 11% or less, 10% or less, 9.5% or less, and particularly preferably 9% or less.

B203 is a component that contributes to the vitrification stability. In particular, when the refractive index nd is as high as 2.00 or more, the vitrification tends to be unstable, but the vitrification stability can be improved by containing an appropriate amount of B₂O₃. A lower limit of the content of B₂O₃ is preferably 0% or more, 0.1% or more, 0.2% or more, 0.5% or more, 1% or more, 2% or more, and particularly preferably 3% or more, and an upper limit thereof is preferably 10% or less, 8% or less, 7% or less, 6% or less, and particularly preferably 5% or less. When the content of B203 is too small, it is difficult to obtain the above effects. On the other hand, when the content of B203 is too large, the refractive index tends to decrease. Note that, in order to increase the vitrification stability and improve mass productivity, it is preferable to appropriately adjust a ratio of SiO₂ and B₂O₃. Specifically, B₂O₃/SiO₂ in term of mass ratio is preferably 0.003 or more, 0.005 or more, 0.02 or more, 0.04 or more, 0.05 or more, 0.1 or more, 0.3 or more, and particularly preferably 0.4 or more, and is preferably 3 or less, 2 or less, 1.5 or less, 1.2 or less, 1 or less, 0.8 or less, 0.6 or less, and particularly preferably 0.5 or less. Note that, in the present invention, “x/y” means a value obtained by dividing the content of x by the content of y.

In the present invention, the content of Si⁴⁺+B3+ (total amount of Si⁴⁺ and B³⁺) is preferably 5% or more, 6% or more, and particularly preferably 7% or more in terms of cation %. Accordingly, the vitrification stability can be improved. An upper limit of the content of Si⁴⁺+B³⁺ is not particularly limited, and when it is too large, the refractive index tends to decrease and the melting temperature tends to increase. Therefore, the upper limit is preferably 40% or less, 35% or less, 30% or less, 25% or less, 20% or less, 19% or less, 15% or less, and particularly preferably 14% or less.

The content of SiO₂+B₂O₃ (total amount of SiO₂ and B₂O₃) is preferably 5% or more, 6% or more, and 7% or more. Accordingly, the vitrification stability can be improved. When the content of SiO₂+B₂O₃ is too large, the refractive index decreases, so that it is preferably 10.4% or less, 9.7% or less, and particularly preferably 8% or less.

BaO is a component that stabilizes the vitrification. However, when the content of BaO increases, the density of the glass increases, and the weight of the optical glass plate tends to increase. Therefore, it is not particularly preferable for applications such as a wearable image display device. Accordingly, a lower limit of the content of BaO is preferably 0% or more, 0.1% or more, 0.3% or more, and particularly preferably 1% or more, and an upper limit thereof is preferably 9% or less, 8% or less, 5% or less, and particularly preferably 3% or less. Note that, when prioritizing weight reduction of the optical glass plate, the content of BaO is preferably 1% or less, and particularly preferably 0.5% or less, and it is most preferable that BaO is not contained.

ZnO is a component that promotes solubility (solubility of raw materials) in the composition system of the present invention. However, when the content thereof is too large, it is difficult to obtain high refractive index properties, and devitrification resistance and acid resistance tend to decrease. Therefore, a lower limit of the content of ZnO is preferably 0% or more, 0.3% or more, 0.5% or more, and particularly preferably 1% or more, and an upper limit thereof is preferably 5% or less, 4% or less, 3% or less, 2.8% or less, 2.5% or less, and particularly preferably 2% or less.

ZrO₂ is a component that increases the refractive index and the chemical durability. However, when the content thereof is too large, the melting temperature tends to be extremely high. Therefore, a lower limit of the content of ZrO₂ is preferably 2% or more, 3% or more, 4% or more, and particularly preferably 5% or more, and an upper limit thereof is preferably 10% or less, 9.5% or less, 9% or less, and particularly preferably 8% or less.

La₂O₃ is a component that remarkably increases the refractive index and also improves the vitrification stability. A lower limit of the content of La₂O₃ is preferably 15% or more, 25% or more, 30% or more, and particularly preferably 35% or more, and an upper limit thereof is preferably 45% or less, and particularly preferably 43% or less. When the content of La₂O₃ is too small, it is difficult to obtain the above effects. On the other hand, when the content of La₂O₃ is too large, devitrification resistance tends to decrease, resulting in poor mass productivity.

Gd₂O₃ is also a component that increases the refractive index and also improves the vitrification stability. A lower limit of the content of Gd₂O₃ is preferably 0% or more, 1% or more, and particularly preferably 2% or more, and an upper limit thereof is preferably 15% or less, 13% or less, 10% or less, 7% or less, and particularly preferably 6% or less. When the content of Gd₂O₃ is too small, it is difficult to obtain the above effects. On the other hand, when the content of Gd₂O₃ is too large, devitrification resistance tends to decrease, resulting in poor mass productivity.

Nb₂O₅ is a component that remarkably increases the refractive index of the glass. However, when the content thereof is too large, the vitrification becomes difficult or a light transmittance in the visible region tends to decrease. Therefore, a lower limit of the content of Nb₂O₅ is preferably 0% or more, 3% or more, and particularly preferably 5% or more, and an upper limit thereof is preferably 15% or less, 12% or less, 10% or less, and particularly preferably 8% or less.

WO₃ is a component that increases the refractive index, but tends to absorb light in the visible region and reduce the light transmittance. Therefore, a lower limit of the content of WO₃ is preferably 0% or more, 0.1% or more, and particularly preferably 1% or more, and an upper limit thereof is preferably 10% or less, 9% or less, 8% or less, 6% or less, 5% or less, 3% or less, and particularly preferably 2% or less. Note that, from the viewpoint of increasing the transmittance in the visible region, the content of WO₃ is preferably 1% or less, and particularly preferably 0.5% or less, and it is most preferable that WO₃ is not contained.

TiO₂ is a component that remarkably increases the refractive index of the glass. However, when the content thereof is too large, the vitrification becomes difficult or a light transmittance in the visible region tends to decrease. Therefore, a lower limit of the content of TiO₂ is preferably 15% or more, 18% or more, 20% or more, 21% or more, 22% or more, and particularly preferably 23% or more, and an upper limit thereof is preferably 50% or less, 40% or less, 35% or less, 30% or less, 29% or less, and particularly preferably 28% or less.

An upper limit of the content of TiO₂+WO₃ (total amount of TiO₂ and WO₃) is preferably 60% or less, 50% or less, 40% or less, 35% or less, 30% or less, 29% or less, 28% or less, and particularly preferably 25% or less, and a lower limit thereof is preferably 15% or more, 18% or more, and particularly preferably 20% or more. Accordingly, the light transmittance in the visible region is easily increased.

Y₂O₃ is a component that increases the refractive index and the chemical durability, but when the content thereof is too large, the melting temperature tends to be extremely high and the vitrification tends to be unstable. Therefore, a lower limit of the content of Y₂O₃ is preferably 0.1% or more, 1% or more, 2% or more, 2.5% or more, and particularly preferably 3% or more, and an upper limit thereof is preferably 10% or less, 7% or less, 6% or less, 5% or less, and particularly preferably 4% or less.

The optical glass plate according to the present invention can contain the following components in addition to the above components.

Ga₂O₃ is a component that forms a glass frame as an intermediate oxide and that expands a range of the vitrification. It also has the effect of increasing the refractive index. However, when the content of Ga₂O₃ is too large, the vitrification becomes difficult. In addition, raw material costs tend to be high. Therefore, a lower limit of the content of Ga₂O₃is preferably 0% or more, 1% or more, and particularly preferably 2% or more, and an upper limit thereof is preferably 10% or less, 7% or less, 6% or less, 5% or less, and particularly preferably 4% or less.

MgO, CaO and SrO are components that stabilize the vitrification. When the content thereof is too large, the refractive index tends to decrease and the liquidus temperature tends to increase. The content of each of these components is preferably 5% or less, 2% or less, 1% or less, and particularly preferably 0.5% or less.

Ta₂O₅ is a component that increases the refractive index. However, when the content thereof is too large, phase separation and devitrification are likely to occur. In addition, since Ta₂O₅ is a rare and expensive component, raw material batch costs increase as the content thereof increases. In view of the above, the content of Ta₂O₅ is preferably 5% or less, 3% or less, and 1% or less, and it is particularly preferable that Ta₂O₅ is not contained.

Yb₂O₃ is a component that increases the refractive index. However, when the content thereof is too large, devitrification and striae are likely to occur. Therefore, the content of Yb₂O₃ is preferably 10% or less, 8% or less, 5% or less, 3% or less, and particularly preferably 1% or less.

In the present invention, in order to increase the refractive index and the light transmittance in the visible region and to improve the vitrification stability, it is preferable to appropriately adjust the ratio (cation ratio) of Y³⁺ to Gd³⁺+Y³⁺+Yb³⁺. Specifically, Y³⁺/(Gd³⁺+Y³⁺+Yb³⁺) is preferably 0.2 or more, 0.25 or more, 0.3 or more, 0.4 or more, 0.5 or more, 0.52 or more, 0.55 or more, and particularly preferably 0.61 or more. In addition, an upper limit thereof is preferably 1 or less, 0.9 or less, and particularly preferably 0.8 or less.

Note that, the “Y³⁺/(Gd³⁺+Y³⁺+Yb³⁺)” means the value obtained by dividing the content of Y³⁺ by the total amount of Gd³⁺, Y³⁺ and Yb³⁺.

Al₂O₃ is a component that improves water resistance. However, when the content thereof is too large, devitrification is likely to occur. Therefore, the content of Al₂O₃ is preferably 5% or less, 3% or less, 1% or less, and 0.5% or less, and it is particularly preferable that Al₂O₃ is substantially not contained. Note that, in the present description, “being substantially not contained” means that it is not intentionally contained as a raw material, and does not exclude containing as an unavoidable impurity. More specifically, in the present description, it means that the content of each component is less than 0.1%.

Li₂O, Na₂O, and K₂O are components that lower the softening point, but when the content thereof is too large, devitrification is likely to occur. Therefore, the content of each of these components is preferably 10% or less, 5% or less, and 1% or less, and it is particularly preferable that these components are substantially not contained. When two or more of Li₂O, Na₂O, and K₂O are contained, the total amount thereof is preferably 10% or less, 5% or less, and 1% or less.

Note that since components (As₂O₃, etc.), Pb components (PbO, etc.), and fluorine components (F₂, etc.) have a large environmental load, it is preferable that these components are substantially not contained. In addition, Bi₂O₃ and TeO₂ are coloring components, and since the transmittance in the visible region is likely to decrease, it is preferable that these components are substantially not contained.

Pt, Rh, and Fe₂O₃ are coloring components, and since the transmittance in the visible region is likely to decrease, it is preferable that the content thereof is small. Specifically, Pt is preferably 10 ppm or less, 9 ppm or less, and particularly preferably 5 ppm or less, Rh is preferably 0.1 ppm or less, and particularly preferably 0.01 ppm or less, and Fe₂O₃ is preferably 1 ppm or less, and particularly preferably 0.5 ppm or less. Note that, from the viewpoint of preventing coloration, the lower the content of Pt, the better it is. Therefore, it is necessary to lower the melting temperature, and as a result, the solubility is likely to decrease. Therefore, in consideration of the solubility, a lower limit of the content of Pt is preferably 0.1 ppm or more, and particularly preferably 0.5 ppm or more.

The optical glass plate according to the present invention may contain each of fining agent components Cl, CeO₂, SO₂, Sb₂O₃, and SnO₂ in a proportion of 0.1% or less.

The optical glass plate according to the present invention has a refractive index (nd) of preferably 2.01 or more, 2.02 or more, 2.04 or more, 2.05 or more, 2.06 or more, 2.07 or more, 2.09 or more, 2.10 or more, and particularly preferably 2.12 or more. When the refractive index is too small, in a case of being used as a light-guiding plate in a wearable image display device such as projector-equipped glasses, an eyeglass-type or goggle-type display, a virtual reality (VR) or augmented reality (AR) display device, and a virtual image display device, a viewing angle tends to be narrower. On the other hand, when the refractive index is too large, defects such as devitrification and striae are likely to occur, so that an upper limit thereof is preferably 2.3 or less, and particularly preferably 2.2 or less.

The optical glass plate according to the present invention has an Abbe number (vd) of preferably 35 or less, 34 or less, 33 or less, 30 or less, 28 or less, and particularly preferably 25 or less, in consideration of the vitrification stability. On the other hand, a lower limit thereof is preferably 15 or more, 18 or more, and particularly preferably 20 or more.

The optical glass plate according to the present invention has an internal transmittance at 450 nm at a thickness of 10 mm of preferably 70% or more, 75% or more, 80% or more, and particularly preferably 85% or more. Accordingly, in the wearable image display device using the optical glass plate according to the present invention, brightness of an image seen by a user is likely to increase.

The optical glass plate according to the present invention has a liquidus temperature of preferably 1350° C. or lower, 1330° C. or lower, and particularly preferably 1300° C. or lower. In addition, the optical glass plate according to the present invention has a liquidus viscosity of preferably 100.1 dPa·s or more, 100.2 dPa·s or more, and particularly preferably 101 dPa·s or more. Accordingly, devitrification is less likely to occur during melting or forming, making it easier to improve the mass productivity.

The optical glass plate according to the present invention has a density of preferably 5.5 g/cm³ or less, 5.3 g/cm³ or less, and particularly preferably 5.1 g/cm³ or less. When the density is too large, the weight of a wearable device using the optical glass plate according to the present invention increases, which increases discomfort when the device is worn. A lower limit of the density is not particularly limited, and when it is too small, other properties such as optical properties tend to decrease. Therefore, the lower limit is preferably 4 g/cm³ or more, and particularly preferably 4.5 g/cm³ or more.

The optical glass plate according to the present invention has an upper limit of a thickness of preferably 1 mm or less, 0.8 mm or less, 0.6 mm or less, and particularly preferably 0.3 mm or less. When the thickness of the optical glass plate is too large, the weight of the wearable image display device using the optical glass plate increases, which increases discomfort when the device is worn. On the other hand, when the thickness of the optical glass plate is too small, mechanical strength tends to decrease. Therefore, a lower limit thereof is preferably 0.01 mm or more, 0.02 mm or more, 0.03 mm or more, 0.04 mm or more, and particularly preferably 0.05 mm or more.

The optical glass plate according to the present invention has a shape of, for example, a plate shape having a polygonal shape such as a circle, an ellipse, or a rectangle in plan view. In this case, the optical glass plate has a major axis (diameter in the case of a circle) of preferably 100 mm or more, 120 mm or more, 150 mm or more, 160 mm or more, 170 mm or more, 180 mm or more, 190 mm or more, and particularly preferably 200 mm or more. When the major axis of the optical glass plate is too small, it becomes difficult to use the optical glass plate for applications such as a wearable image display device. In addition, the mass productivity tends to be poor. An upper limit of the major axis of the optical glass plate is not particularly limited, and is realistically 1000 mm or less.

The optical glass plate according to the present invention can be prepared by obtaining a molten glass by melting raw materials mixed to obtain a predetermined glass composition, then forming the molten glass, and then performing post-processing such as cutting and polishing as necessary. During the melting, a platinum crucible, an aluminum crucible, a quartz crucible, an aluminum nitride crucible, a boron nitride crucible, a zirconia crucible, a silicon carbide crucible, a molybdenum crucible, a tungsten crucible, and the like can be used. The form of the raw material is not particularly limited, and for example, a powdered raw material or glass cullet can be used.

Note that, the optical glass plate may be produced by preparing a glass cullet by melting raw materials mixed to obtain a predetermined glass composition, and then reheating only the glass cullet.

Note that, the melting temperature is preferably 1400° C. or lower, 1350° C. or lower, 1300° C. or lower, and particularly preferably 1280° C. or lower. When the melting temperature is too high, components (Pt, Rh, etc.) of a melting container tend to dissolve into a glass melt, and the light transmittance of the resulting optical glass plate tends to decrease. On the other hand, when the melting temperature is lower, bubbles and foreign substances (for example, foreign substances derived from undissolved materials) tend to be more likely to occur. Therefore, in order to reduce bubbles and foreign substance in the glass, the melting temperature is preferably 1200° C. or higher, and particularly preferably 1250° C. or higher.

The optical glass plate according to the present invention is suitably used as a light-guiding plate, which is a constituent member of a wearable image display device selected from projector-equipped glasses, an eyeglass-type or goggle-type display, a virtual reality (VR) or augmented reality (AR) display device, and a virtual image display device. The light-guiding plate is used in a so-called glasses lens part of a wearable image display device, and plays the role of guiding light emitted from an image display element included in the wearable image display device and emitting the light toward the eyes of the user. It is preferable that a diffraction grating is provided on the surface of the light-guiding plate to diffract the light emitted from the image display element into the inside of the light-guiding plate.

### EXAMPLES

Hereinafter, the present invention will be described in detail using Examples, but the present invention is not limited to these Examples.

Tables 1 to 9 show Examples of the present invention (Nos. 1 to 10 and Nos. 13 to 49) and Comparative Examples (Nos. 11 and 12).

TABLE 1

| | | Unit | 1 | 2 | 3 | 4 | 5 | 6 |
|---|---|---|---|---|---|---|---|---|
| Glass | SiO₂ | mass % | 8.3 | 8.3 | 8.3 | 8.2 | 8.3 | 6.9 |
| | B₂O₃ | | 4.2 | 4.2 | 4.2 | 4.2 | 4.2 | 3.5 |
| | ZnO | | 1.3 | 1.0 | 2.6 | 1.3 | 1.7 | 1.3 |
| | ZrO₂ | | 6.8 | 6.8 | 6.8 | 6.7 | 6.8 | 6.4 |
| | La₂O₃ | | 39.6 | 39.6 | 39.5 | 39.3 | 39.9 | 44.3 |
| | Gd₂O₃ | | 2.9 | 2.9 | 2.9 | 2.9 | 2.9 | 2.7 |
| | Nb₂O₅ | | 7.6 | 7.6 | 7.6 | 8.6 | 6.7 | 7.2 |
| | TiO₂ | | 26.0 | 26.3 | 24.8 | 25.5 | 26.2 | 24.6 |
| | Y₂O₃ | | 3.3 | 3.3 | 3.3 | 3.3 | 3.3 | 3.1 |
| | BaO | | | | | | | |
| | SrO | | | | | | | |
| | Ga₂O₃ | | | | | | | |
| | WO3 | | | | | | | |
| | Pt | ppm by | 5 | 6 | — | 5 | — | — |
| | Rh | mass | <0.01 | <0.01 | — | <0.01 | — | — |
| | Fe₂O₃ | | <0.5 | <0.5 | — | <0.5 | — | — |
| | B₂O₃/SiO₂ | mass % | 0.51 | 0.51 | 0.51 | 0..51 | 0.51 | 0.51 |
| | TiO₂ + WO₃ | | 26.0 | 26.3 | 24.8 | 25.5 | 26.2 | 24.6 |
| | Y³⁺/(Gd³⁺ + Y³⁺ + | cation % | 0.65 | 0.65 | 0.65 | 0.65 | 0.65 | 0.65 |
| | Yb³⁺)Si⁴⁺ + B³⁺ | | 25.7 | 25.7 | 25.7 | 25.7 | 25.9 | 22.5 |

| | | | | | | | |
|---|---|---|---|---|---|---|---|
| Refractive index (nd) | — | 2.06 | 2.08 | 2.07 | 2.08 | 2.08 | 2.09 |
| Abbe numver (vd) | — | 24.0 | 24.0 | 32.7 | 23.1 | 25.0 | 24.5 |
| Internal transmittance τ450 | % | 83 | — | — | 82 | — | — |
| Liquidus temperature | ° C. | 1250 | 1290 | 1290 | 1270 | 1290 | — |
| Liquidus viscosity logη | dPa · s | 0.2 | — | 0.1 | 0.2 | — | — |
| Density | g/cm³ | 4.81 | 4.81 | 4.86 | 4.81 | 4.81 | — |

TABLE 2

| | | Unit | 7 | 8 | 9 | 10 | 11 | 12 |
|---|---|---|---|---|---|---|---|---|
| Glass | SiO₂ | mass % | 8.7 | 8.2 | 8.1 | 7.3 | 3.3 | 5.5 |
| | B₂O₃ | | 3.6 | 4.2 | 4.1 | 2.3 | 5.7 | 8.3 |
| | ZnO | | 1.3 | 1.3 | 4.6 | 0.3 | | |
| | ZrO₂ | | 6.8 | 8.6 | 8.6 | 9.1 | 5.6 | 5.8 |
| | La₂O₃ | | 39.7 | 39.3 | 39.1 | 37.4 | 41.3 | 44.5 |
| | Gd₂O₃ | | 2.9 | 2.9 | 2.8 | 6.0 | | 7.6 |
| | Nb₂O₅ | | 7.6 | 7.6 | 8.5 | 7.2 | 10.2 | 7.6 |
| | TiO₂ | | 26.1 | 24.6 | 20.9 | 24.6 | 22.3 | 14.4 |
| | Y₂O₃ | | 3.3 | 3.3 | 3.3 | 5.8 | | 5.2 |
| | BaO | | | | | | 11.6 | |
| | SrO | | | | | | | 1.1 |
| | Ga₂O₃ | | | | | | | |
| | WO3 | | | | | | | |
| | Pt | ppm by | 5 | 6 | 5 | 7 | — | 4 |
| | Rh | mass | <0.01 | <0.01 | <0.01 | <0.01 | — | <0.01 |
| | Fe₂O₃ | | <0.5 | <0.5 | <0.5 | <0.5 | — | <0.5 |
| | B₂O₃/SiO₂ | mass % | 0.41 | 0.51 | 0.51 | 0.32 | 1.73 | 1.51 |
| | TiO₂ + WO₃ | | 26.1 | 24.6 | 20.9 | 24.6 | 22.3 | 14.4 |
| | Y³⁺/(Gd³⁺ + Y³⁺ + | cation % | 0.65 | 0.65 | 0.65 | 0.61 | 0.00 | 0.52 |
| | Yb³⁺)Si⁴⁺ + B³⁺ | | 25.2 | 25.7 | 25.7 | 20.1 | 23.0 | 33.5 |

| | | | | | | | |
|---|---|---|---|---|---|---|---|
| Refractive index (nd) | — | 2.08 | 2.08 | 2.06 | 2.10 | — | 2.00 |
| Abbe number (vd) | — | 23.2 | 22.7 | 24.8 | 23.6 | — | 28.6 |
| Internal transmittance τ450 | % | 81 | 76 | 75 | 75 | — | 96 |
| Liquidus temperature | ° C. | — | 1290 | 1290 | 1290 | — | 1150 |
| Liquidus viscosity logη | dPa · s | — | 0.1 | 0.1 | 0.1 | — | 0.9 |
| Density | g/cm³ | 4.81 | 4.81 | 4.72 | 5.04 | — | 5.05 |

TABLE 3

| | | Unit | 13 | 14 | 15 | 16 | 17 | 18 |
|---|---|---|---|---|---|---|---|---|
| Glass | SiO₂ | mass % | 7.3 | 7.0 | 7.1 | 7.2 | 7.5 | 7.4 |
| | B₂O₃ | | 2.7 | 2.6 | 2.6 | 2.6 | 2.7 | 2.7 |
| | ZnO | | 0.3 | 0.3 | 0.3 | 1.2 | 1.3 | 0.3 |
| | ZrO₂ | | 7.8 | 7.6 | 7.6 | 7.8 | 8.1 | 7.9 |
| | La₂O₃ | | 41.7 | 42.7 | 40.6 | 41.5 | 38.1 | 41.3 |
| | Gd₂O₃ | | 4.2 | 4.0 | 4.0 | 4.1 | 4.3 | 3.6 |
| | Nb₂O₅ | | 7.6 | 9.3 | 11.2 | 8.5 | 8.8 | 7.9 |
| | TiO₂ | | 24.3 | 22.5 | 22.6 | 23.0 | 25.0 | 24.7 |
| | Y₂O₃ | | 4.1 | 4.0 | 4.0 | 4.1 | 4.2 | 4.2 |
| | BaO | | | | | | | |
| | SrO | | | | | | | |
| | Ga₂O₃ | | | | | | | |
| | WO3 | | | | | | | |
| | Pt | ppm by | — | — | — | — | — | 6 |
| | Rh | mass | — | — | — | — | — | <0.01 |
| | Fe₂O₃ | | — | — | — | — | — | <0.5 |
| | B₂O₃/SiO₂ | mass % | 0.37 | 0.37 | 0.37 | 0.36 | 0.36 | 0.36 |
| | TiO₂ + WO₃ | | 24.3 | 22.5 | 22.6 | 23.0 | 25.0 | 24.7 |
| | Y³⁺/(Gd³⁺ + Y³⁺ + | cation % | 0.61 | 0.61 | 0.61 | 0.61 | 0.61 | 0.61 |
| | Yb³⁺)Si⁴⁺ + B³⁺ | | 21.0 | 20.7 | 20.7 | 20.8 | 21.1 | 21.2 |

| | | | | | | | |
|---|---|---|---|---|---|---|---|
| Refractive index (nd) | — | 2.1 | 2.1 | 2.1 | 2.1 | 2.09 | 2.10 |
| Abbe number (vd) | — | 23.6 | 22.0 | 20.5 | 22.8 | 22.5 | 23.4 |
| Internal transmittance τ450 | % | 84 | — | — | 85 | — | — |
| Liquidus temperature | ° C. | — | — | — | — | — | — |
| Liquidus viscosity logη | dPa · s | — | — | — | — | — | — |
| Density | g/cm³ | 5.00 | 5.00 | 5.00 | 5.00 | 4.95 | 4.99 |

TABLE 4

| | | Unit | 19 | 20 | 21 | 22 | 23 | 24 |
|---|---|---|---|---|---|---|---|---|
| Glass | SiO₂ | mass % | 7.5 | 7.7 | 8.0 | 7.7 | 7.5 | 8.2 |
| | B₂O₃ | | 2.7 | 2.7 | 2.8 | 2.8 | 2.8 | 3.5 |
| | ZnO | | 0.3 | 0.3 | 0.3 | 0.3 | 0.6 | 0.8 |
| | ZrO₂ | | 8.0 | 8.1 | 8.1 | 8.2 | 7.5 | 8.4 |
| | La₂O₃ | | 41.0 | 40.5 | 39.7 | 37.9 | 40.6 | 38.6 |
| | Gd₂O₃ | | 3.3 | 2.7 | 1.7 | 3.7 | 3.0 | 1.4 |
| | Nb₂O₅ | | 8.0 | 8.3 | 8.8 | 8.2 | 8.1 | 8.5 |
| | TiO₂ | | 24.9 | 25.3 | 26.0 | 26.8 | 24.8 | 25.9 |
| | Y₂O₃ | | 4.3 | 4.4 | 4.6 | 4.4 | 5.1 | 4.7 |
| | BaO | | | | | | | |
| | SrO | | | | | | | |
| | Ga₂O₃ | | | | | | | |
| | WO3 | | | | | | | |
| | Pt | ppm by | — | — | — | — | — | — |
| | Rh | mass | — | — | — | — | <0.01 | <0.01 |
| | Fe₂O₃ | | — | — | — | — | <0.5 | <0.5 |
| | B₂O₃/SiO₂ | mass % | 0.36 | 0.35 | 0.35 | 0.36 | 0.37 | 0.43 |
| | TiO₂ + WO₃ | | 24.9 | 25.3 | 26.0 | 26.8 | 24.8 | 25.9 |
| | Y³⁺/(Gd³⁺ + Y³⁺ + | cation % | 0.68 | 0.73 | 0.81 | 0.66 | 0.74 | 0.84 |
| | Yb³⁺)Si⁴⁺ + B³⁺ | | 21.3 | 21.6 | 21.9 | 21.5 | 21.4 | 24.0 |

| | | | | | | | |
|---|---|---|---|---|---|---|---|
| Refractive index (nd) | — | 2.1 | 2.1 | 2.1 | 2.11 | 2.10 | 2.09 |
| Abbe number (vd) | — | 23.2 | 23.1 | 22.9 | 22.6 | 23.4 | 23.1 |
| Internal transmittance τ450 | % | — | — | — | — | — | — |
| Liquidus temperature | ° C. | — | — | — | — | — | — |
| Liquidus viscosity logη | dPa · s | — | — | — | — | — | — |
| Density | g/cm³ | 5.00 | 5.00 | 5.00 | 4.98 | 5.04 | 4.83 |

TABLE 5

| | | Unit | 25 | 26 | 27 | 28 | 29 | 30 |
|---|---|---|---|---|---|---|---|---|
| Glass | SiO₂ | mass % | 9.1 | 6.4 | 7.8 | 8.0 | 7.2 | 7.4 |
| | B₂O₃ | | 4.9 | 7.0 | 5.4 | 2.8 | 2.6 | 2.9 |
| | ZnO | | 0.3 | 0.4 | 0.4 | 0.4 | 0.3 | 0.4 |
| | ZrO₂ | | 8.6 | 7.4 | 7.4 | 8.2 | 7.6 | 7.5 |
| | La₂O₃ | | 36.6 | 39.6 | 39.7 | 38.8 | 39.9 | 40.3 |
| | Gd₂O₃ | | 1.9 | 1.4 | 1.4 | 1.1 | 3.5 | 3.2 |
| | Nb₂O₅ | | 8.5 | 8.7 | 8.7 | 9.0 | 7.6 | 8.3 |
| | TiO₂ | | 25.4 | 24.5 | 24.6 | 25.8 | 23.9 | 24.9 |
| | Y₂O₃ | | 4.7 | 4.6 | 4.6 | 4.7 | 4.1 | 5.1 |
| | BaO | | | | | | | |
| | SrO | | | | | | | |
| | Ga₂O₃ | | | | | | | |
| | WO3 | | | | | 1.2 | 3.3 | |
| | Pt | ppm by | — | — | — | 7 | 8 | — |
| | Rh | mass | — | — | — | <0.01 | <0.01 | — |
| | Fe₂O₃ | | — | — | — | <0.5 | <0.5 | — |
| | B₂O₃/SiO₂ | mass % | 0.54 | 1.09 | 0.69 | 0.35 | 0.36 | 0.39 |
| | TiO₂ + WO₃ | | 25.4 | 24.5 | 24.6 | 27.0 | 27.2 | 24.9 |
| | Y³⁺/(Gd³⁺ + Y³⁺ + | cation % | 0.8 | 0.85 | 0.85 | 0.88 | 0.66 | 0.70 |
| | Yb³⁺)Si⁴⁺ + B³⁺ | | 28.4 | 29.8 | 28.2 | 22.1 | 20.9 | 21.50 |

| | | | | | | | |
|---|---|---|---|---|---|---|---|
| Refractive index (nd) | — | 2.06 | 2.06 | 2.07 | 2.10 | 2.10 | 2.10 |
| Abbe number (vd) | — | 23.4 | 27.1 | 25 | 23.3 | 23.6 | 23.7 |
| Internal transmittance τ450 | % | — | — | — | — | — | — |
| Liquidus temperature | ° C. | — | — | — | — | — | — |
| Liquidus viscosity logη | dPa · s | — | — | — | — | — | — |
| Density | g/cm³ | 4.75 | 4.76 | 4.76 | 5.06 | 5.20 | 5.20 |

TABLE 6

| | | Unit | 31 | 32 | 33 | 34 | 35 |
|---|---|---|---|---|---|---|---|
| Glass | SiO₂ | mass % | 5.8 | 5.8 | 5.8 | 7.0 | 6.7 |
| | B₂O₃ | | 1.0 | 1.0 | 1.0 | 0.3 | 0.5 |
| | ZnO | | 1.5 | 1.8 | 1.5 | 0.6 | 1.5 |
| | ZrO₂ | | 7.5 | 7.5 | 7.5 | 7.5 | 7.6 |
| | La₂O₃ | | 39.3 | 39.3 | 40.6 | 40.3 | 40.6 |
| | Gd₂O₃ | | 3.9 | 3.9 | 3.9 | 4.1 | 3.9 |
| | Nb₂O₅ | | 7.7 | 7.7 | 7.7 | 7.6 | 7.7 |
| | TiO₂ | | 23.5 | 23.2 | 23.8 | 23.0 | 23.3 |
| | Y₂O₃ | | 4.2 | 4.2 | 4.2 | 4.1 | 4.2 |
| | BaO | | | | | | |
| | SrO | | | | | | |
| | Ga₂O₃ | | | | | 2.3 | |
| | WO3 | | 5.6 | 5.6 | 4.0 | 3.2 | 4.0 |
| | Pt | ppm by | 9 | 8 | 9 | 8 | 5 |
| | Rh | mass | <0.01 | <0.01 | <0.01 | <0.01 | <0.01 |
| | Fe₂O₃ | | <0.5 | <0.5 | <0.5 | <0.5 | <0.5 |
| | B₂O₃/SiO₂ | mass % | 0.17 | 0.17 | 0.17 | 0.04 | 0.07 |
| | TiO₂ + WO₃ | | 29.1 | 28.8 | 27.8 | 26.2 | 27.3 |
| | Y³⁺/(Gd³⁺ + Y³⁺ + | cation % | 0.63 | 0.63 | 0.63 | 0.62 | 0.63 |
| | Yb³⁺)Si⁴⁺ + B³⁺ | | 14.3 | 14.3 | 14.2 | 14.1 | 14.3 |

| | | | | | | |
|---|---|---|---|---|---|---|
| Refractive index (nd) | — | 2.14 | 2.13 | 2.15 | 2.12 | 2.13 |
| Abbe number (vd) | — | 22.6 | 22.7 | 22.5 | 23.2 | 22.7 |
| Internal transmittance τ450 | % | 70 | — | — | 75 | — |
| Liquidus temperature | ° C. | — | — | — | — | 1250 |
| Liquidus viscosity logη | dPa · s | — | — | — | — | — |
| Density | g/cm³ | 5.26 | 5.21 | 5.30 | 5.23 | — |

TABLE 7

| | | Unit | 36 | 37 | 38 | 39 | 40 |
|---|---|---|---|---|---|---|---|
| Glass | SiO₂ | mass % | 6.7 | 7.0 | 5.9 | 7.2 | 5.8 |
| | B₂O₃ | | 0.5 | 0.3 | 1.1 | 0.2 | 1.0 |
| | ZnO | | 1.5 | 0.6 | 1.9 | 0.5 | 1.8 |
| | ZrO₂ | | 7.5 | 7.4 | 7.5 | 7.5 | 7.5 |
| | La₂O₃ | | 40.2 | 40.1 | 40.2 | 40.2 | 40.3 |
| | Gd₂O₃ | | 4.4 | 4.1 | 4.4 | 4.1 | 3.9 |
| | Nb₂O₅ | | 7.6 | 7.6 | 7.7 | 7.8 | 7.7 |
| | TiO₂ | | 22.8 | 22.8 | 23.0 | 22.9 | 23.1 |
| | Y₂O₃ | | 4.3 | 4.1 | 4.3 | 4.1 | 4.1 |
| | BaO | | 0.5 | | | | |
| | SrO | | | | | | |
| | Ga₂O₃ | | | | | 2.3 | |
| | WO3 | | 4.0 | 6.0 | 4.0 | 5.5 | 4.8 |
| | Pt | ppm by | 5 | 5 | 6 | 6 | 5 |
| | Rh | mass | <0.01 | <0.01 | <0.01 | <0.01 | <0.01 |
| | Fe₂O₃ | | <0.5 | <0.5 | <0.5 | <0.5 | <0.5 |
| | B₂O₃/SiO₂ | mass % | 0.07 | 0.04 | 0.19 | 0.03 | 0.17 |
| | TiO₂ + WO₃ | | 26.8 | 28.8 | 27.0 | 28.4 | 27.9 |
| | Y³⁺/(Gd³⁺ + Y³⁺ + | cation % | 0.61 | 0.62 | 0.61 | 0.62 | 0.63 |
| | Yb³⁺)Si⁴⁺ + B³⁺ | | 14.4 | 14.4 | 14.4 | 14.4 | 14.2 |

| | | | | | | |
|---|---|---|---|---|---|---|
| Refractive index (nd) | — | 2.13 | 2.13 | 2.13 | 2.13 | 2.13 |
| Abbe number (vd) | — | 22.6 | 22.9 | 22.5 | 22.9 | 22.7 |
| Internal transmittance τ450 | % | — | 78 | — | 78 | — |
| Liquidus temperature | ° C. | — | 1270 | — | — | — |
| Liquidus viscosity logη | dPa · s | — | — | — | — | — |
| Density | g/cm³ | 5.22 | 5.26 | 5.22 | 5.26 | 5.22 |

TABLE 8

| | | Unit | 41 | 42 | 43 | 44 | 45 |
|---|---|---|---|---|---|---|---|
| Glass | SiO₂ | mass % | 6.7 | 5.8 | 6.7 | 7.6 | 6.7 |
| | B₂O₃ | | 0.5 | 1.0 | 0.5 | 2.9 | 3.8 |
| | ZnO | | 1.5 | 1.5 | 1.5 | 1.7 | 1.7 |
| | ZrO₂ | | 7.5 | 7.4 | 7.5 | 6.2 | 6.2 |
| | La₂O₃ | | 40.2 | 40.1 | 40.6 | 36.4 | 36.5 |
| | Gd₂O₃ | | 4.4 | 4.1 | 4.2 | 12.9 | 12.8 |
| | Nb₂O₅ | | 7.6 | 7.6 | 7.7 | 6.5 | 6.5 |
| | TiO₂ | | 22.7 | 22.9 | 23.1 | 22.8 | 22.8 |
| | Y₂O₃ | | 4.3 | 4.1 | 4.2 | 3.0 | 3.0 |
| | BaO | | | | | | |
| | SrO | | 0.6 | | | | |
| | Ga₂O₃ | | | | | | |
| | WO3 | | 4.0 | 5.5 | 4.0 | | |
| | Pt | ppm by | 8 | 7 | 4 | 9 | 8 |
| | Rh | mass | <0.01 | <0.01 | <0.01 | <0.01 | <0.01 |
| | Fe₂O₃ | | <0.5 | <0.5 | <0.5 | <0.5 | <0.5 |
| | B₂O₃/SiO₂ | mass % | 0.07 | 0.17 | 0.07 | 0.38 | 0.57 |
| | TiO₂ + WO₃ | | 26.7 | 28.4 | 27.1 | 22.8 | 22.8 |
| | Y³⁺/(Gd³⁺ + Y³⁺ + | cation % | 0.61 | 0.62 | 0.62 | 0.27 | 0.27 |
| | Yb³⁺)Si⁴⁺ + B³⁺ | | 14.3 | 14.3 | 14.4 | 22.3 | 23.5 |

| | | | | | | |
|---|---|---|---|---|---|---|
| Refractive index (nd) | — | 2.13 | 2.13 | 2.13 | 2.06 | 2.06 |
| Abbe number (vd) | — | 22.6 | 22.9 | 23.1 | 24.3 | 24.3 |
| Internal transmittance τ450 | % | — | — | 75 | — | — |
| Liquidus temperature | ° C. | — | 1300 | 1240 | — | — |
| Liquidus viscosity logη | dPa · s | — | — | — | — | — |
| Density | g/cm³ | 5.21 | — | 5.26 | 4.72 | 4.72 |

TABLE 9

| | | Unit | 46 | 47 | 48 | 49 |
|---|---|---|---|---|---|---|
| Glass | SiO₂ | mass % | 7.3 | 7.3 | 6.8 | 6.9 |
| | B₂O₃ | | 0.05 | | 0.3 | 0.3 |
| | ZnO | | 0.3 | 0.3 | 0.6 | 0.6 |
| | ZrO₂ | | 7.4 | 7.4 | 7.4 | 7.4 |
| | La₂O₃ | | 40.05 | 40.1 | 39.8 | 39.9 |
| | Gd₂O₃ | | 4.1 | 4.1 | 4.0 | 4.1 |
| | Nb₂O₅ | | 7.5 | 7.6 | 7.5 | 7.5 |
| | TiO₂ | | 22.5 | 22.5 | 22.0 | 22.1 |
| | Y₂O₃ | | 4.1 | 4.1 | 4.1 | 4.1 |
| | BaO | | | | | |
| | SrO | | 0.6 | | | |
| | Ga₂O₃ | | | | | 1.2 |
| | WO3 | | 6.7 | 6.6 | 7.5 | 5.9 |
| | Pt | ppm by | 4 | 4 | — | — |
| | Rh | mass | <0.01 | <0.01 | — | — |
| | Fe₂O₃ | | <0.5 | <0.5 | — | — |
| | B₂O₃/SiO₂ | mass % | 0.01 | 0.00 | 0.04 | 0.04 |
| | TiO₂ + WO₃ | | 29.2 | 29.1 | 29.5 | 28.0 |
| | Y³⁺/(Gd³⁺ + Y³⁺ + | cation % | 0.61 | 0.62 | 0.62 | 0.27 |
| | Yb³⁺)Si⁴⁺ + B³⁺ | | 14.3 | 14.3 | 14.4 | 22.3 |

| | | | | | |
|---|---|---|---|---|---|
| Refractive index (nd) | — | 2.13 | 2.13 | 2.13 | 2.13 |
| Abbe number (vd) | — | 22.9 | 22.7 | 22.8 | 23.0 |
| Internal transmittance τ450 | % | 86 | 85 | 86 | 87 |
| Liquidus temperature | ° C. | 1280 | 1280 | — | — |
| Liquidus viscosity logη | dPa · s | 0.5 | 0.5 | — | — |
| Density | g/cm³ | 5.27 | 5.27 | 5.31 | 5.28 |

Glass raw materials mixed to have the respective compositions shown in Tables 1 to 9 were melted at 1250°° C. to 1400° C. for 2 hours using a platinum crucible. Subsequently, the molten glass was poured onto a carbon plate and annealed for 2 to 48 hours to obtain a glass sample.

Regarding the obtained glass sample, the refractive index (nd), the Abbe number (vd), the internal transmittance (1450), the liquidus temperature, the liquidus viscosity, and the density were measured as follows. The results are shown in Tables 1 to 9.

The refractive index was shown as a value measured against a d-line (587.6 nm) of a helium lamp.

The Abbe number was calculated according to an equation of Abbe number (vd)=[(nd−1)/(nF−nC)] using the above refractive index of the d-line, and values of the refractive index of an F line (486.1 nm) of a hydrogen lamp and a C-line (656.3 nm) of the hydrogen lamp.

The internal transmittance was measured as follows. Optically polished samples having a thickness of 10 mm±0.1 mm and a thickness of 3 mm±0.1 mm were prepared, and the light transmittance (linear transmittance) including a surface reflection loss was measured at an interval of 1 nm using a spectrophotometer (UV-3100, manufactured by Shimadzu Corporation). An internal transmittance curve for a thickness of 10 mm was determined based on the light transmittance data for thicknesses of 10 mm and 3 mm. The internal transmittance at a wavelength of 450 nm was read from the obtained internal transmittance curve.

The liquidus temperature and the liquidus viscosity were determined as follows.

A crushed glass sample was melted at 1350° C., and the temperature was lowered at a rate of −1.5° C./min while observing with a high-temperature observation microscope (MS-18SP, manufactured by YONEKURA MFG. Co., Ltd.), and the temperature at which precipitated crystals were found was defined as the liquidus temperature (crystal precipitation temperature).

Separately, a lumpy glass sample was charged into an alumina crucible and heated and melted. Regarding the obtained glass melt, the viscosities of the glass at a plurality of temperatures were determined by the platinum ball pulling method. Subsequently, using the measured values of the viscosity of the glass, a viscosity curve was created by calculating the constant of the Vogel-Fulcher equation. In the created viscosity curve, the viscosity corresponding to the liquidus temperature determined above was defined as the liquidus viscosity.

The density was measured by the Archimedes method using a glass sample weighing approximately 10 g.

As shown in Tables 1 to 9, glass samples Nos. 1 to 10 and Nos. 13 to 49, which are Examples, had desired optical constants such as a refractive index of 2.06 to 2.15 and an Abbe number of 20.5 to 32.7. On the other hand, glass sample No. 11 as Comparative Example was devitrified. In addition, glass sample No. 12 as Comparative Example had a low refractive index of 2.00.

### INDUSTRIAL APPLICABILITY

The optical glass plate according to the present invention is suitably used as a light-guiding plate in a wearable image display device selected from projector-equipped glasses, an eyeglass-type or goggle-type display, a virtual reality (VR) or augmented reality (AR) display device, and a virtual image display device.

1. An optical glass plate comprising, in terms of mass %, 0% to 12% of SiO₂, 0% to 10% of B₂O₃, 0% to 9% of BaO, 0% to 5% of ZnO, 2% to 10% of ZrO₂, 15% to 45% of La₂O₃, 0% to 15% of Gd₂O₃, 0% to 15% of Nb₂O₅, 0% to 10% of WO₃, 15% to 50% of TiO₂, and 0.1% to 10% of Y₂O₃, wherein a ratio Y³⁺/(Gd³⁺+Y³⁺+Yb³⁺) is 0.2 or more in terms of cation %, a refractive index nd is 2.01 or more, and an Abbe number vd is 35 or less.

2. The optical glass plate according to claim 1, wherein an internal transmittance 1450 at a wavelength of 450 nm at a thickness of 10 mm is 70% or more.

3. The optical glass plate according to claim 1, wherein a thickness is 1 mm or less.

4. The optical glass plate according to claim 1, wherein a major axis of a main surface is 100 mm or more.

5. The optical glass plate according to claim 1, wherein a liquidus viscosity is 100.1 dPa·s or more.

6. The optical glass plate according to claim 1, wherein a density is 5.5 g/cm³ or less.

7. A light-guiding plate comprising the optical glass plate according to claim 1.

8. The light-guiding plate according to claim 7, which is used in a wearable image display device selected from projector-equipped glasses, an eyeglass-type or goggle-type display, a virtual reality (VR) or augmented reality (AR) display device, and a virtual image display device.

9. A wearable image display device comprising the light-guiding plate according to claim 7.
